(19) United States
(12) Patent Application Publication
(10) Pub. No.: US 2002/0028681 A1
(43) Pub. Date: Mar. 7, 2002

(54) Method for collecting information and providing information service based on locational and geographical information

(76) Inventors: Soong-Bok Lee, Seoul (KR); Yun-Sik Kim, Seoul (KR); Wan-Jong Chun, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/739,557

(22) Filed: Dec. 15, 2000

(30) Foreign Application Priority Data
Aug. 21, 2000 (KR) 2000-48274

(51) Int. Cl. H04Q 7/20

(52) U.S. Cl. 455/456; 455/414

(57) ABSTRACT

Disclosed are methods for collecting information and providing an information service based on locational and geographical information as well as to a recording medium containing a program readable by a computer for realizing the methods thereof. The methods according to the invention include the steps of: receiving information on a subscriber collected according to a request for a service provision including information on a current location and a version of a currently designated map leaf and according to a predetermined condition; confirming whether or not the version of the current map is an updated version by using the received locational information and information on boundaries of each map leaf established in a geographical information database; and transmitting information on a request for a service provision depending on whether or not the version of the map leaf is an updated one.

### FIELD OF THE INVENTION

The present invention relates to methods for collecting information and providing an information service based on locational and geographical information as well as to a recording medium containing a program readable by a computer for realizing the methods thereof; and in more particular, to a method for collecting information and providing an information service based on locational and geographical information by using a locating technology in a wireless telecommunication system including a next generation mobile telecommunication network such as a wireless local loop (WLL), a band width wireless local loop (B-WLL), a cellular phone network, a personal communication system network, an intelligent transportation system (ITS) network, other cellular phone networks currently on use overseas, an international mobile telecommunication-2000 (IMT-2000), an universal mobile telecommunication service (UMTS), etc. as well as in a wire telecommunication system to confirm location of a mobile terminal and to provide additional services by combining locational information with geographical information through interlocking with a geographical information search system, and a recording medium containing a program readable by a computer for realizing the above methods.

### DESCRIPTION OF THE PRIOR ART

In general, the locating technology can be classified into a network-based technology, a terminal-based technology, a dedicated line-based technology, etc. The following is a detailed explanation of the locating technology.

A network-based technology is a locating method by using a base station constituting a mobile telecommunication network. The parameters required for this method can be classified into an angle of arrival (AOA), a time of arrival (TOA), a time difference of arrival (TDOA), an oscillating width, a phase, an intensity of signals, etc. Performing measurement of locations with respect to such parameters by means of a network is referred to the network-based technology. The parameters may be received by a base station or by a terminal so as to be transferred to the network.

When using the network-based technology, locating can be performed without any additional equipment and without changing an existing terminal.

The rules and regulations on a network-based technology of the U.S. Federal Communications Commission stipulate that locating can be performed by an error range of 100m with respect to a wireless enhanced 911 (E911) service until “Oct. 1, 2001”.

A terminal-based technology can be referred to a global positioning system (GPS)-based technology. To be specific, the terminal-based technology is a method for locating one's current position by using signal information of a GPS satellite received by a GPS module housed in a terminal. The terminal-based technology can be classified into a method of locating one's current position by means of a GPS module, and a method of locating one's current position through exchange of data with an equipment of a network having information on a terminal housing a GPS module and a GPS satellite.

Using an externally mounted GPS poses incurs an additional expense for purchasing a GPS and causes inconvenience of carrying a large-sized terminal.

A dedicated line-based technology is a technology of using a dedicated line for locating. This technology uses a frequency other than the one used in a wireless telecommunication system in general. An example is a manner of using a dedicated line of a band width in the U.S. location and monitoring system (LMS), which uses separate signals for locating. This manner is a kind of signposting manner, and base stations at roadsides of ITS are an example using this manner.

The dedicated line-based technology is generally uneconomical because an additional network should be established for locating. On the other hand, this technology guarantees a high degree of precision if dedicated lines are installed in some areas by laying out separate signals for a particular applicability.

Another method similar to the network-based methods described above is a locating technology using a radio-camera by receiving signals transmitted from a terminal of a network.

The radio-camera technology is a locating method by comparing a wireless signal form already known for a particular area with a fingerprint of a wireless signal form. According to this technology, it is possible to consecutively locate one's positions irrespective of a user's self-request for location by using a database of user's signals received through multipaths as well as of wireless signal waves already established. However, this technology poses problems of incurring a considerable amount of expenses both in establishing a database of wireless signals and in maintaining and renewing the database whenever the circumstances change.

Another available method is a locating method by means of base stations or a sector identifier (ID) within the area of base stations, though not using any particular locating technology. To be specific, a user's position can be located by base stations, which provide services for a digital cellular mobile telecommunication system or a PCS system, or a sector ID within the area of base stations. Because of a variety of base stations of a cellular mobile telecommunication system or a PCS system or of sector sizes within the area of base stations, however, the degree of precision in locating one's position has a wide range of deviation.

The present invention relates to providing an information service and a method for collecting information for the purpose of providing additional services by locating a mobile terminal with a locating technology and by combining a technology of presenting locational information with a geographic information system (GIS) through interlocking with a geographical information search system based on the information obtained by location.

Meanwhile, the conventional location-based data information service has a drawback of storing all the data in a terminal or in a server. Thus, the user is either unable to avail of the dynamically changing information when the data are stored in a terminal or needs to download all the data required for the service from the server, thereby requiring a considerable amount of data communication to be benefited by a detailed information service.

Another conventionally available method is a method of collecting information by sensing velocities of vehicles running on a road with an equipment including a velocity sensing device, such as a beacon, around a road so as to current information on a traffic amount, which is indispensable for a subscriber moving with a vehicle. However, this method also poses a problem of installing the equipment around all the roads to collect information such as the transportation information.

### SUMMARY OF THE INVENTION

It is, therefore, an object of the invention to provide methods for collecting information based on locational and geographical information and providing an information service for the purpose of presenting additional services by locating a terminal with a locating technology and by combining a location information technology with a geographic information technology through interlocking with a geographic information search system, as well as a recording medium containing a program readable by a computer for realizing the methods thereof.

In accordance with an aspect of the present invention, there is provided methods for collecting information and providing an information service based on locational and geographical information, including the steps of: receiving information from a terminal on a request for service provision including information on a current location, on a version of a currently designated map leaf and on a subscriber collected according to a predetermined condition; confirming whether or not the version of the currently designated map leaf is an updated version by using information on boundaries of each map leaf established in a database of the received locational information and geographical information; and transmitting information on a request for service provision depending on whether or not the version of the map leaf is an updated version. The method further includes the step of confirming whether or not there has been a request for additional service provision according to the transmitted information, and transmitting the corresponding information from a service providing system.

In accordance with another aspect of the present invention, there is also provided a computer readable recording medium containing a program for executing a method for collecting information based on locational and geographical information applicable to a wire or wireless telecommunication system, the method comprising the steps of: a) receiving information on a request for a service provision including information on a current location and a version of a currently designated map leaf, and on a subscriber collected according to a predetermined condition; b) confirming whether or not the version of the current map leaf is an updated one by using the received locational information and information on boundaries of each map leaf established in a geographical information database; and c) transmitting information on a request for a service provision depending on whether or not the version of the map leaf is an updated one.

### BRIEF DESCRIPTION OF THE DRAWINGS

The above and other objects, features and advantages of the present invention will become more apparent from the following detailed description when taken in conjunction with the accompanying drawings, in which:

FIG. 1 is an exemplary diagram illustrating a construction of a wireless telecommunication system, to which the present invention is applicable;

FIG. 2 is a block diagram illustrating a construction of an information collecting device and an information service providing system based on locational and geographical information according to an embodiment of the present invention;

FIGS. 3A and 3B are flow charts illustrating the flow of methods for collecting information and providing an information service based on locational and geographical information according to an embodiment of the present invention;

FIG. 4 is a procedural diagram illustrating the methods for collecting information and providing an information service based on locational and geographical information in FIGS. 3A and 3B; and

FIGS. 5A and 5B are flow charts illustrating a procedure of collecting information on a subscriber among the methods for collecting information and providing an information service based on locational and geographical information according to an embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

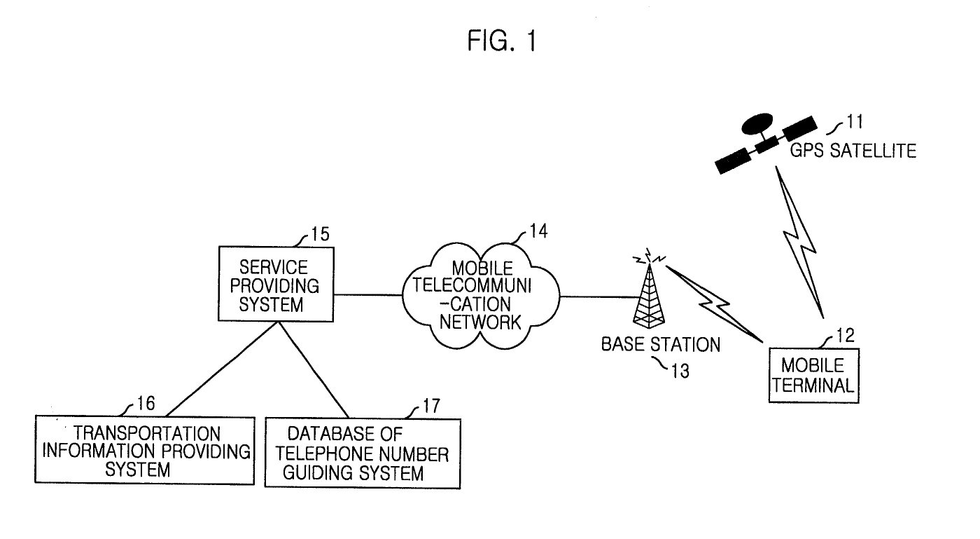

FIG. 1 is an exemplary diagram illustrating a construction of a wireless telecommunication system, to which the present invention is applicable. FIG. 1 shows a method for providing a service when a mobile terminal 12 houses a GPS receiving device.

Referring to FIG. 1, a data telecommunication network for providing a service comprises a mobile terminal 12, a base station 13, a mobile telecommunication network 14, a service providing system 15, a transportation information providing system 16 and a telephone number guiding database 17.

If the information on a location of a mobile terminal 12 or a device similiar thereto, a type of the terminal, an original ID of the terminal, etc. is transmitted to the base station 13 by means of diverse locating technologies, the base station 13 identifies the information. Accordingly, this information is transmitted to the service providing system 15 via the mobile telecommunication network.

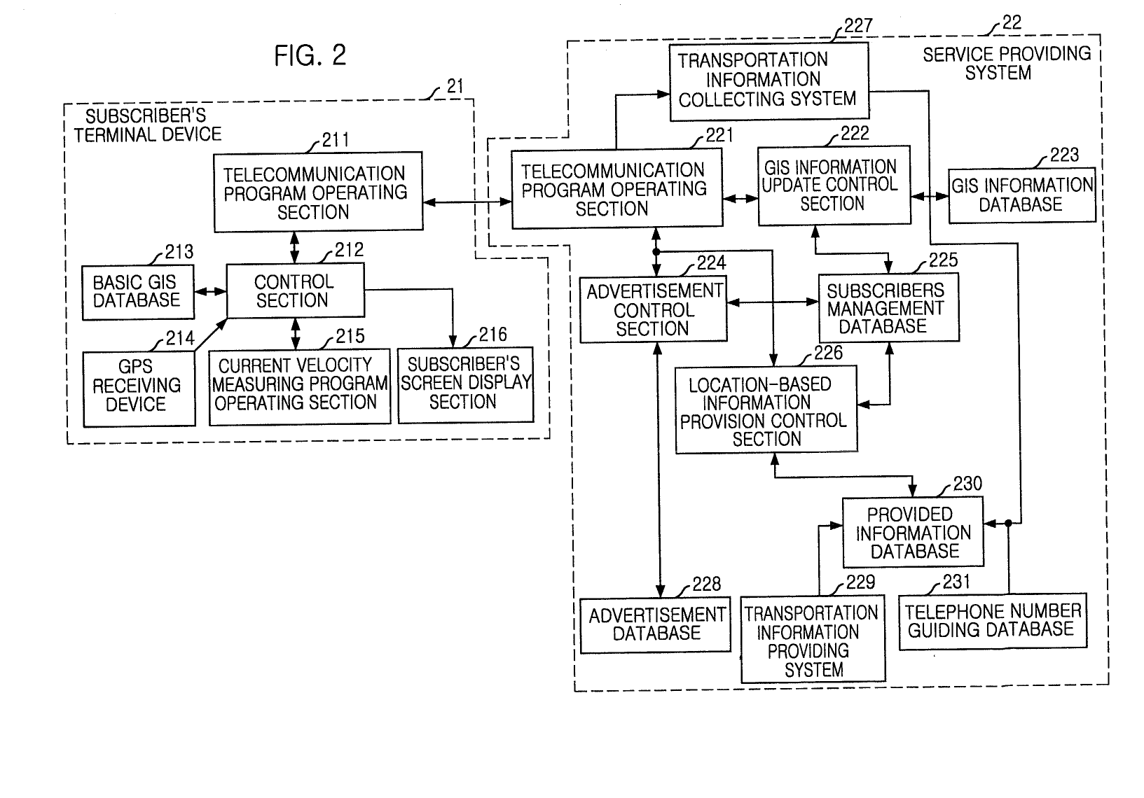

FIG. 2 is a block diagram illustrating a construction of an information collecting device and an information service providing system based on locational and geographical information according to an embodiment of the present invention.

Referring to FIG. 2, a subscriber's terminal device 21 for providing a service according to the present invention comprises a telecommunication program operating section 211, a control section 212, a basic GIS database 213, a GPS receiving device 214, a current velocity prediction program operating section 215, and a subscriber's screen display section 216.

The service providing system 22 for a service provision according to the present invention comprises a telecommunication program operating section 221, a GIS information update control section 222, a GIS information database 223, an advertisement control section 224, a subscriber management database 225, a location-based information provision control section 226, a transportation information collecting system 227, an advertisement database 228, a transportation information providing system 229, a provided information database 230, and a telephone number guiding database 231.

The subscriber's terminal device 21 provides a base car navigation system (CNS) service through a subscriber's screen by means of basic geographical information and the GPS receiving device 214.

The control section 212 controls an operation of the subscriber's terminal device 21, and confirms a version of a map leaf of the current subscriber's terminal to transmit the same to the service providing system 22 upon request for an additional information provision by the subscriber. This is for the purpose of receiving an updated map leaf via a telecommunication network when the current map leaf is not an updated one. If the subscriber requests information not contained in the basic geographical information stored in the control section, a service can be requested to the service providing system 22 via the telecommunication program operating section 211. If necessary, the service providing system 22 searches the provided information database 230 among the map renewal information (road searches or building satellite cities, etc.) for renewing the corresponding basic geographical information and the information on map properties by means of a location-based information provision control section 226 so as to transmit the information requested by the subscriber to the subscriber's terminal device 21. The control section 212 then displays the received information on the subscriber's screen display section 216.

The telecommunication program operating section 211 performs a same function as a web browser in an internet data communication, and exchanges data with the service providing system 22 by being interlocked with the telecommunication program operating section 221 of the service providing system 22.

The basic GIS database 213 includes geographical information for a basic locating service, and is used for providing basic services based on locational and geographical information. If the subscriber has requested additional information, the basic GIS database 213 provides an information service via the subscriber's screen display section 216 in combination with the data from the service providing system 22.

The GPS receiving device 214 receives signals from GPS satellites, and is used to locate the current position of the subscriber's terminal device 21. The GPS receiving device 214 also provides a basic service and additional information services in combination with the data from the basic geographical information data and the service providing system 22.

The subscriber's screen display section 216 is used to transfer geographical information, additional information and advertisements necessary for a service provision to the subscriber via a screen.

The service providing system 22 provides services in response to a request for a service provision by the subscriber made via the telecommunication program operating section 221.

If the subscriber's request for a service provision including the information on the current position and the version of a map leaf is received, the GIS information renewal control section 222 confirms the information on the subscriber. If the request is confirmed to be effective, and if the version of the map leaf of the subscriber is not an updated one, the GIS information renewal control section 222 transmits the data required for renewing the map leaf of the subscriber's terminal based on the updated GIS data managed by the GIS information database 223 to the subscriber via the telecommunication program operating section 221. If the version of the maps leaf of the subscriber is an updated one, the location-based information provision control section 226 provides the subscriber with the requested information on the location.

If necessary, advertisement information satisfying the subscriber's favorites is provided by searching the advertisement database 228 with reference to the information on the subscriber in the subscriber management database 225 managing the subscription status, IDs, passwords, occupations, favoritesites, etc. of the subscribers. The information in the transportation information providing system 229 and the telephone number guiding database 231 is supplied to the service providing system 22 at predetermined intervals, respectively so as to renew the data in the provided information database 230.

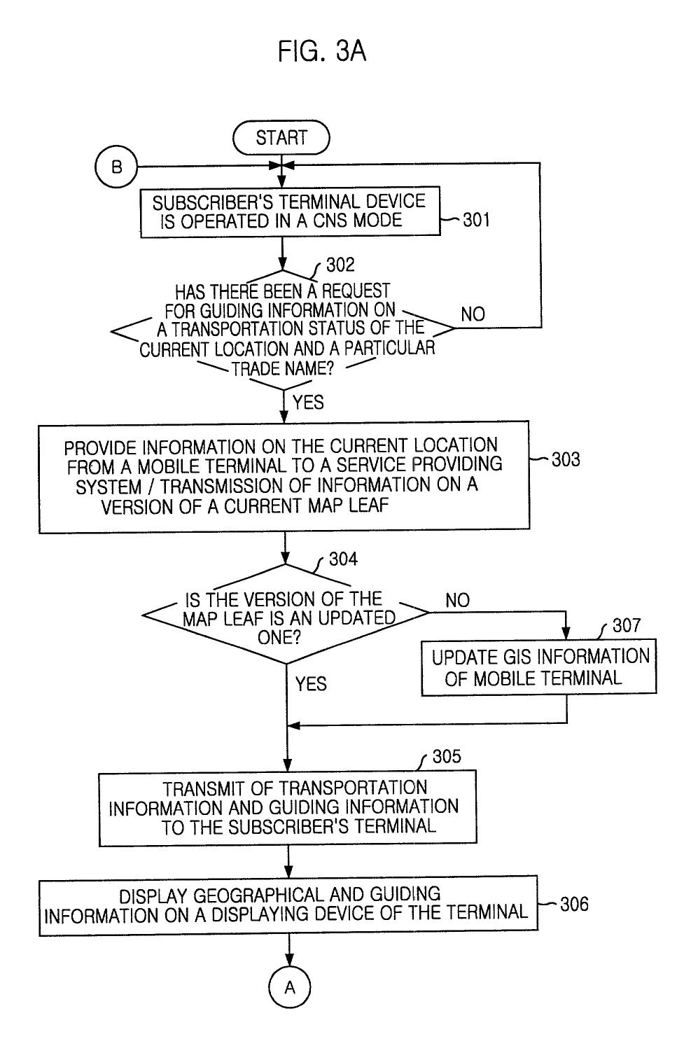

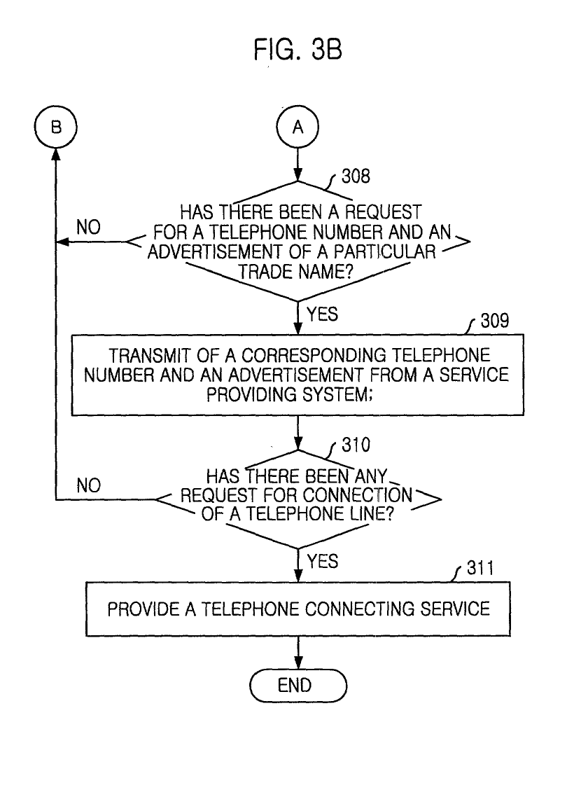

FIGS. 3A and 3B are flow charts illustrating the flow of methods for collecting information and providing an information service based on locational and geographical information according to an embodiment of the present invention.

Referring to FIGS. 3A and 3B, the subscriber's terminal operates in a CNS mode based on the GPS-receiving signals and the basic geographical information at step 301.

The subscriber's terminal then confirms whether or not the subscriber requests guiding information on a transportation status of the current area and on a particular trade name at step 302.

In the negative, the subscriber's terminal repeatedly performs the CNS mode operation. In the affirmative, the subscriber's terminal transmits the information on the current location, the requested guiding information and the current map version to the service providing system via the mobile terminal at step 303.

The service providing system then confirms whether or not the map version is an updated version at step 304. In the affirmative, the transportation information and the guiding information are transmitted to the subscriber's terminal at step 305, and the geographical information and the guiding information are displayed on the displaying device of the subscriber's terminal at step 306. In the negative, the corresponding GIS information on the map leaf is updated at step 307, and the transportation information and the guiding information are transmitted to the subscriber's terminal at step 305.

The subscriber may select additional guiding information from the information displayed on the current screen. It is confirmed whether or not the subscriber requests a telephone number of a particular trade name and a promoting advertisement at step 308. In the negative, the subscriber's terminal repeatedly performs the CNS operation mode at step 301. In the affirmative, the subscriber's terminal requests the corresponding data to the service providing system, and searches the corresponding information from the database interlocked with the telephone number guiding database at step 309.

Then, the subscriber's terminal displays the guiding information such as a telephone number or an advertisement provided by the service providing system on the subscriber's screen, and confirms whether or not the subscriber requests a telephone connecting service at step 310.

In the affirmative, the telephone connecting service is provided at step 311. In the negative, the subscriber's terminal repeatedly performs the CNS operation mode at step 301.

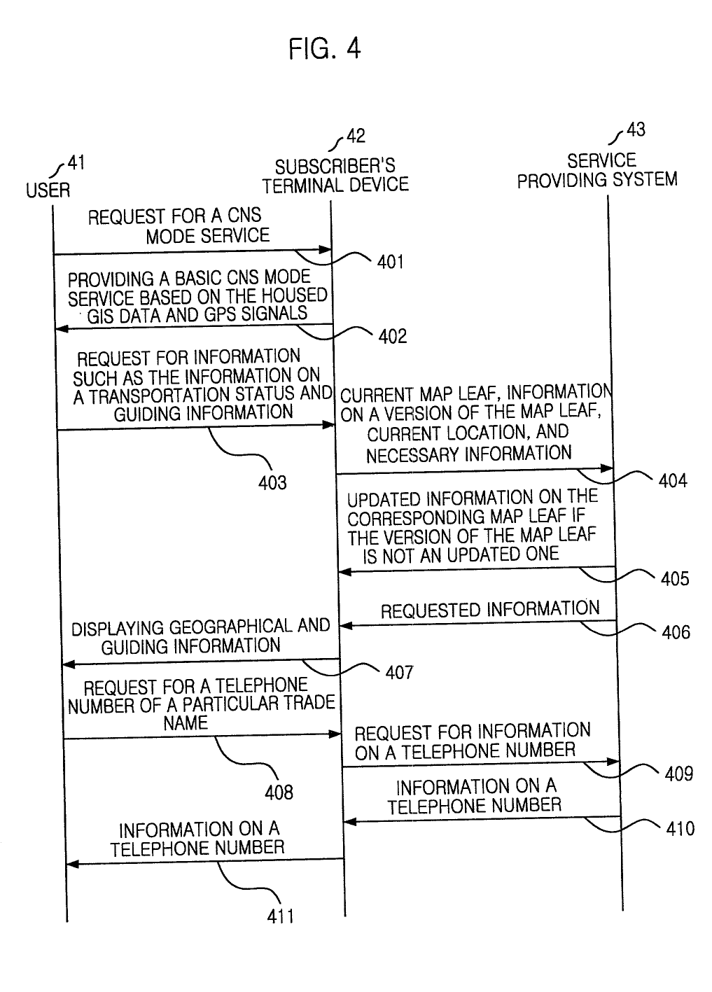

FIG. 4 is a procedural diagram illustrating the methods for collecting information and providing an information service based on locational and geographical information in FIGS. 3a and 3b.

Referring to FIG. 4, if a user 41 requests a CNS mode service via a subscriber's terminal device 42, the subscriber's terminal device 42 provides the user 41 with a basic CNS mode service based on GIS data stored therein and GPS signals at step 402.

At the request for information such as transportation information and guiding information from the user 41, the subscriber's terminal device 42 requests a service providing system 43 to provide information on the current map, version of the map, current location and other necessary information, etc. at step 404.

The service providing system 43 receiving such a request provides updated information on the map requested by the subscriber's terminal device 42 if the corresponding map is not an updated one at step 405, and provides the subcriber's terminal device 42 with other requested information at step 406. If the map is an updated one, the service providing system 43 provides the subscriber's terminal device 42 with other requested information at step 406.

Subsequently, the subscriber's terminal device 42 displays the geographical information and the guiding information provided by the service providing system 43 on a screen of the user 41 at step 407.

Meanwhile, in the user 41 requests information on a telephone number of a particular trade name to the subscriber's terminal device 42, the subscriber's terminal device 42 requests the corresponding data to the service providing system 43. The service providing system 43 then searches the corresponding information among the database interlocked with the telephone number guiding database, and transmits the same to the subscriber's terminal device 42. Here, the subscriber's terminal device 42 provides the user 41 with the information on the requested telephone number at step 411.

In the meantime, to collect information such as the transportation amount for a data provision service, each of the subscribers' terminals generates information on a velocity of the terminal based on the locational information and the chronological information of the terminal, and transmits the same to the service providing system 43.

Here, the information on a velocity of the terminal is not generated by all the terminals but by the terminals satisfying certain conditions such as whether the terminal is currently located on a road, or whether or not a velocity has ever exceeded a predetermined level during the last predetermined period of time. Such a data transmission may be enforcibly performed or ceased upon request by the service providing system. In the absence of such a request, the data transmission is automatically controlled depending on the status of telecommunication of the upward link of the wireless network, i.e., depending on the telecommunication load. In order to calculate information on a velocity, the distance moved during a predetermined period of time unit is stored, and an average of such plurality of velocities is obtained to predict the velocity.

An operation of the process of collecting information on the subscriber described above will now be described in further detail.

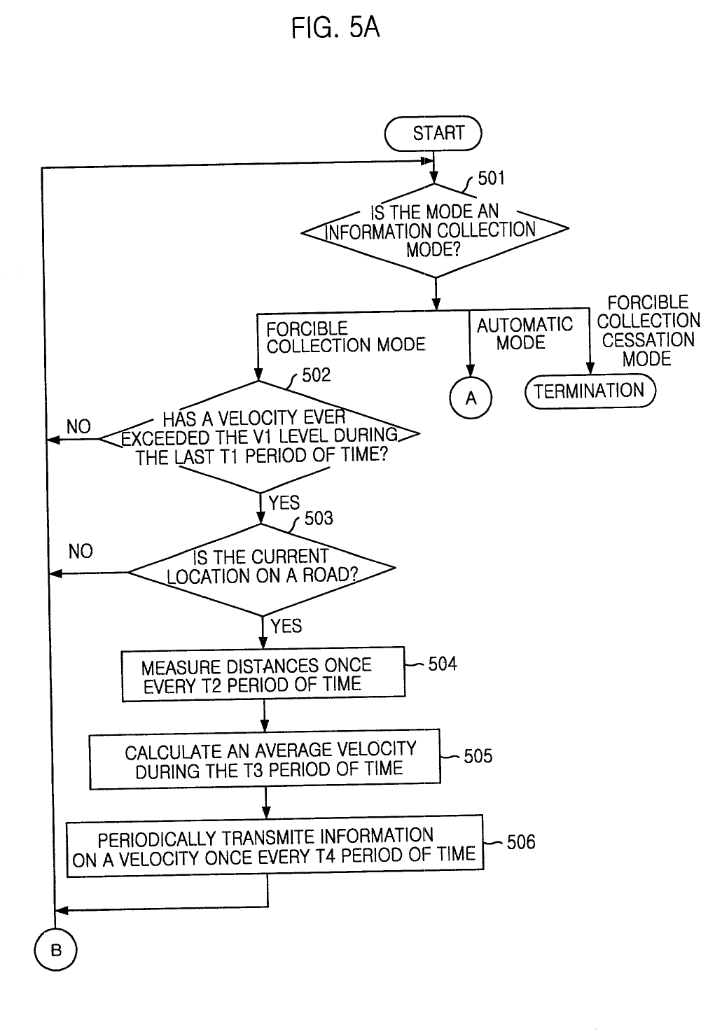

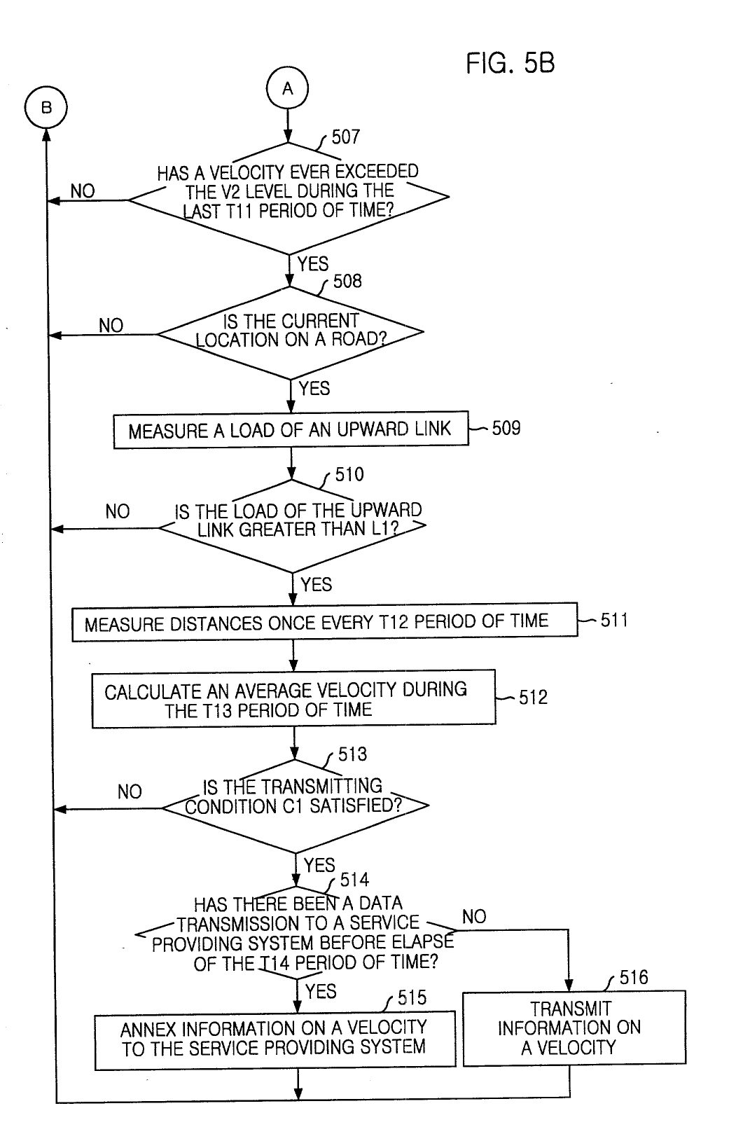

FIGS. 5A and 5B are flow charts illustrating a procedure of collecting information on a subscriber among the methods for collecting information and providing an information service based on locational and geographical information according to an embodiment of the present invention.

Referring to FIGS. 5A and 5B, an information collection mode of the subscriber's terminal device designated by the service providing system is confirmed to collect information from the subscriber's terminal device at step 501.

If the information collection mode is a forcible collection mode, no process is performed related to the information collection.

If the information collection mode has been set to a forcible collection mode, it is first confirmed whether or not a velocity has ever exceeded V1 during the last T1 period of time at step 502. In the negative, the information collection mode is confirmed at step 501. In the affirmative, it is confirmed whether or not the current location is on a road at step 503. In the negative, the information collection mode is confirmed at step 501. In the affirmative, distance is measured once every T2 period of time. The information on time and distance is stored at step 504, and an average velocity during the T3 period of time is calculated based on the stored information on time and distance at step 505. The information on velocity is periodically transmitted once every T4 period of time at step 506. The information collection mode is then confirmed at step 501.

As a last process, if the information collection mode is an automatic mode, it is first confirmed whether or not the velocity has ever exceeded V11 level during the last T11 period of time at step 507. In the affirmative, the information collection mode is confirmed at step 501. In the negative, it is confirmed whether or not the current location is on a road at step 508. In the negative, the information collection mode is confirmed at step 501. In the affirmative, the load of the upward link is predicted at step 509.

It is further confirmed whether or not the load of the upward link is below a predetermined level (below L1) at step 510. In the negative, the information collection mode is confirmed at step 501. In the affirmative, distance is measured once every T12 period of time, and the information on time and distance is stored at step 511. An average velocity during the T13 period of time is calculated based on the stored information on time and distance at step 512. Subsequently, it is determined whether or not the average velocity satisfies a predetermined condition for a data transmission at step 513. In the negative, the information collection mode is confirmed at step 501. In the affirmative, it is confirmed whether or not there exist any data to be transmitted to the service providing system before elapse of a T14 period of time at step 514.

In the affirmative, the information on a velocity is annexed to the data transmitted to the service providing system at step 515. In the negative, the information on a velocity is solely transmitted at step 516. The information collection mode is then confirmed at step 501.

Here, the predetermined condition for a data transmission may be the method of transmitting data only when the current velocity pertains to an adjacent group out of the current group excluding the case when the current velocity pertains to the same group even if the time elapses. Otherwise, the condition may be set to transmit data only when the current velocity pertains to a particular group.

As described above, the present invention has an effect of locating a position of a mobile terminal by using a locating technology as well as of providing enhanced services through combination of the location information technology with geographical information technology by interlocking with a geographical information search system.

The present invention has another effect of providing locational information, spatial information and related geographical information without attaching any additional devices to a wire and wireless telecommunication system, thereby benefiting the modern people of frequent movements with a rapid spread of mobile terminals.

Although the preferred embodiments of the invention have been disclosed for illustrative purpose, those skilled in the art will be appreciate that various modifications, additions and substitutions are possible, without departing from the scope and spirit of the invention as disclosed in the accompanying claims.

What is claimed is:

1. A method for collecting information based on locational and geographical information applicable to a wire or wireless telecommunication system, the method comprising the steps of:
a) confirming an information collection mode of a terminal to collect information via the terminal according to a predetermined condition;
b) not performing a process related to the information collection if the information collection mode confirmed in the step a) is a forcible collection cessation mode;
c) locating a current position of the terminal and confirming whether or not a velocity has ever exceeded a predetermined level during a predetermined period of time if the information collection mode is a forcible collection mode, and forcibly transmitting data upon request by a service providing system; and
d) predicting a velocity by measuring moved distances at predetermined time intervals so as to include data in the information transmitted to the service providing system or to automatically control data transmission depending on a telecommunication status of an upward link of the wireless network, and by obtaining an average value of information on a plurality of velocities.

2. A method for collecting information and providing an information service based on locational and geographical information applicable to a wire or wireless telecommunication system, the method comprising the steps of:
a) receiving information on a subscriber collected according to a request for a service provision including information on a current location and a version of a currently designated map leaf and according to a predetermined condition;
b) confirming whether or not the version of the current map is an updated version by using the received locational information and information on boundaries of each map leaf established in a geographical information database; and
c) transmitting information on a request for a service provision depending on whether or not the version of the map leaf is an updated one.

3. The method as recited in claim 2, further comprising the step of d) confirming whether or not there has been any request for additional information based on the transmitted information, and transmitting the corresponding information from the service providing system.

4. The method as recited in claim 3, wherein the step d) is characterized by searching provided information database to provide the corresponding information according to the additional information requested by the subscriber, and searching an advertisement database according to the information on the subscriber in a subscriber management database managing a subscribing status, an ID, a password, an occupation and favoritesites of the subscriber to provide advertisement information satisfying the subscriber's favorites.

5. The method as recited in claim 2, wherein the step a) includes the steps of:
a1) confirming an information collection mode of the terminal to collect information via the terminal according to a predetermined condition;
a2) not performing a process related to the information collection if the information collection mode confirmed in the step a) is a forcible collection cessation mode;
a3) forcibly performing a data transmission in response to a request from the service providing system by locating the current position of the terminal and by confirming whether or not a velocity has ever exceeded during a predetermined period of time; and
a4) predicting a velocity by measuring moved distances at predetermined time intervals so as to include data in the information transmitted to the service providing system or to automatically control data transmission depending on a telecommunication status of an upward link of the wireless network, and by obtaining an average value of information on a plurality of velocities, if the information collection mode is an automatic mode.

6. The method as recited in claim 5, wherein the step c) includes the steps of:
c1) transmitting transportation information and guiding information to provide locational information as requested by the subscriber upon request from the terminal, and displaying geographical information and guiding information on a display device of the terminal, if the version of the map leaf confirmed in the step b) is an updated version; and
c2) transmitting information on the map leaf if the version of the current map leaf is not an updated one, to renew the corresponding basic geographical information in real time and to proceed with the step c1).

7. The method as recited in claim 6, wherein the information on a request for a service provision is the guiding information on the transportation status of the current location and on a particular trade name.

8. A computer readable recording medium containing a program for executing a method for collecting information based on locational and geographical information applicable to a wire or wireless telecommunication system, the method comprising the steps of:
a) receiving information on a request for a service provision including information on a current location and a version of a currently designated map leaf, and on a subscriber collected according to a predetermined condition;
b) confirming whether or not the version of the current map leaf is an updated one by using the received locational information and information on boundaries of each map leaf established in a geographical information database; and
c) transmitting information on a request for a service provision depending on whether or not the version of the map leaf is an updated one.

9. The recording medium as recited in claim 8, further comprising the step of: confirming whether or not there has been any request for additional information according to the transmitted information, and transmitting the corresponding information from a service providing system.
